(19) United States
(12) Patent Application Publication
(10) Pub. No.: US 2005/0283414 A1
(43) Pub. Date: Dec. 22, 2005

(54) Remote system management

(76) Inventors: Curtis T. Fernandes, Corona, CA (US); Gina Marie McLaren, Laguna Niguel, CA (US); Roger Johnson, Foothill Ranch, CA (US); Cindy Mason, San Clemente, CA (US)

Correspondence Address: FISH & RICHARDSON, PC, 12390 EL CAMINO REAL, SAN DIEGO, CA, 92130-2081, US

(21) Appl. No.: 10/970,119

(22) Filed: Oct. 20, 2004

Related U.S. Application Data
(60) Provisional application No. 60/580,844, filed on Jun. 17, 2004.

(51) Int. Cl. G06F 17/60

(52) U.S. Cl. 705/34

(57) ABSTRACT

The disclosure is a system for and method of performing automated billing and other client-related activities on a remote computer system.

### CROSS REFERENCE TO RELATED APPLICATIONS

This application claims priority under 35 U.S.C. §119 to U.S. Provisional Application Ser. No. 60/580,844, filed Jun. 17, 2004, the disclosure of which is incorporated herein by reference in its entirety.

### TECHNICAL FIELD

This disclosure relates to automating the performance of a variety of tasks on remotely located computing-systems or devices. More particularly, the disclosure relates to performing automated billing, remote diagnostics, messaging, and upgrading for remotely located computers via a local computing device.

### BACKGROUND

Businesses may offer computing systems or devices to be used by their customers. Rather than charge the customer outright for purchase and ownership, the business can charge a leasing fee and/or variable fee based on usage. Therefore, the system or device is placed at the customer's location. As part of the agreement, the business that provided the system often remains responsible for various aspects of its operation including troubleshooting. A technician may need to fix, diagnose, or upgrade the computing system. This may require visiting a customer's site. However, with larger customers it may be unmanageable to send someone to the customer each time a troubleshooting situation arises. Troubleshooting is only example of issues that may need to be addressed when a business has remotely located systems in which activities need to be performed.

Using conventional remote-control software, an individual at a business can dial a customer's computer via modem or other communications protocol, take control of the customer's computer, and perform certain tasks on the customer's system without being on site. For example, U.S. Pat. No. 6,633,905, entitled, “System and method for accessing and operating personal computers remotely,” describes a remote access device for capturing, digitizing, and communicating video signals from a host computer to a remote computer. The remote computer returns keyboard and mouse signals through the remote access device to the host computer to control the host computer as though the remote keyboard and mouse were directly connected to the host computer.

Billing may be important in these systems. The business providing the system may need to charge its customers for using the computing system. In the event that billing is based on individual usage, the remote system might capture and store usage data in the form of an amount of time or number of uses, for example. Therefore, this usage data may be transmitted back from the remote system to the provider so that the customer can be invoiced. However, customers might have more than one system across, more than one location in which billing should be collected. Billing may be further complicated, given that a certain amount or specified types of usage should not be billed.

### SUMMARY

The disclosure provides methods and systems that improve the accessibility of remotely located computing systems.

The disclosure also provides methods and systems to eliminate or reduce the need for human interaction to perform actions on remotely located computing systems.

The disclosure provides methods and systems to improve the billing and invoicing processes for customers by using one or more remotely located computing systems.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 illustrates a high-level functional diagram of a system for performing automated billing and other customer-related tasks on a remote computing system.

FIG. 2 illustrates a method of performing a series of automated tasks across a number of remote computing systems.

FIG. 3 illustrates a method of invoice generation by using downloaded billing and customer information from a number of remote computing systems.

Like reference symbols in the various drawings indicate like elements.

### DETAILED DESCRIPTION

The disclosure describes a system for and method of performing automated billing and other customer-related tasks on remote computer systems. A user of a host computer determines and schedules connections from the host to a list of remote computer systems and schedules the tasks to perform on each system. The host computer connects to each remote computer system and performs each task automatically. Software application functionality or data residing on remote computer systems may be used as part of the task. Invoicing is performed by aggregating usage information, determining additional billing fees, and grouping associated billing data for each customer. Invoices are then uploaded back to remote computer systems.

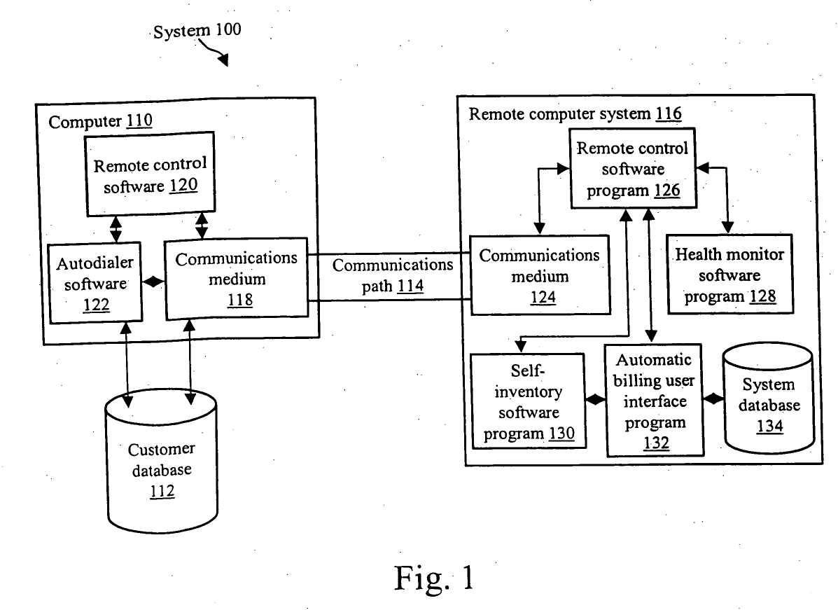

FIG. 1 illustrates a high-level functional diagram of a system 100 for performing automated billing and other customer-related tasks on a remote computing device. System 100 includes a computer 110, a customer database 112, a communications path 114, and a remote computer system 116. Computer 110 further includes a communications medium 118, a remote control software program 120, and an autodialer software program 122. Remote computer system 116 further includes a communications medium 124, a remote control software program 126, a health monitor software program 128, a self-inventory software program 130, an automatic billing user interface program 132, and a system database 134.

Computer 110 connects to and automates a series of tasks to be performed on or using remotely located computing systems. Computer 110 is representative of any conventional or special-purpose computer, such as a desktop, laptop, or server computer. Computer 110 contains communications medium 118 for communicating with remote computing systems via communications path 114. The path 114 may be via a modem, network adapter, such as wireless access points or satellite receivers, or the like. Computer 110 can have more than one communications medium 118 device for enabling multiple, simultaneous connections. For example, computer 110 might contain two modems connected to two different phone lines. This may enable computer 110 to maintain simultaneous connections on two remote computers. Computer 110 also contains remote control software 120 for controlling and working with remote computing systems securely. While communications medium 118 establishes the communications link to a remote computer, remote control software 120 allows a user at computer 110 to control this remote computer securely and emulate the local computing environment of the remote computer. This includes uploading, downloading, and executing files on the remote system. While a standard, off-the-shelf software package, such as Symantec's pcAnywhere™ provides the necessary functionality of remote control software 120, a custom software program could also be used. Given that a number of different tasks might need to be performed across a number of different remote computer systems, computer 110 further contains custom autodialer software 122, which allows a user to manage and schedule execution of these tasks across multiple remote computer systems and then perform them automatically. Autodialer software 122 therefore enables computer 110 to communicate with a number of remote computing systems at any time and without requiring human intervention. Autodialer software 122 may also have access to customer database 112, where some or all information necessary for the automation of these tasks is stored. For example, customer database 112 stores the connection information for each remote computing system, such as the phone number at which the customer's computer is connected to a telephone line via a modem.

A list of the specific tasks for each customer may also be stored within customer database 112. Alternately, autodialer software 122 may also store the tasks by using conventional application storage techniques, such as saving them in a file.

Remote computer system 116 represents the computer system that a host computer needs to connect to and perform certain tasks. Remote computer system 116 is representative of any conventional or special-purpose computer with a display (not shown), such as a desktop, laptop, or server computer. Furthermore, remote computer system 116 contains communications medium 124 for communicating with other remote computing systems via communications path 114.

Remote computer system 116 also contains remote control software program 126 for securely connecting to and allowing control by a host computer.

Remote computer system 116 also contains a number of custom software programs. While certain ones are specifically described in this disclosure; it should be understood that additional software programs could be added to remote computer system 116. These programs may interact with various components of remote computer system 116. A function of these programs may include to provide information that a host computer can download, retrieve information that a host computer has uploaded, and/or perform functions specified by the host computer.

A health monitor software program 128 is a custom software program that verifies the state and integrity of services or programs running on remote computer system 116. For example, health monitor software program 128 verifies that communications medium 124 (such as a modem or network interface card) is working properly and that remote control software program 126 is running on remote computer system 116. Therefore, if a host computer is unable to connect to remote computer system 116, a user at remote computer system 116 can troubleshoot the connection problem by using health monitor software program 128. A host computer with control can also check or download a health monitor software program 128 log.

Self-inventory software program 130 is a custom software program that checks the version of other software programs that are running on remote computer system 116. If an update is available for a software program, the update file or files can be transferred from a host computer to remote computer system 116 and executed on remote computer system 116.

Automatic billing user interface program 132 is a custom software program that interfaces with system database 134 to access billing information. While billing information is shown collected and stored in system database. 134, it could also be collected and stored by using other conventional data storage means.

Furthermore, while system database 134 is shown within remote computer system 116 in FIG. 1, system database 134 can also be located outside remote computer system 116 on another computer, server, or across another network. Billing information can then be downloaded to a host computer via remote control software program 126.

In operation, autodialer software 122-on computer 110 finds a connection (telephone or network based) and task information in customer database 112 or other conventional storage location. Autodialer software 122 then initiates a new connection session through remote control software 120, which provides connection information, such as a telephone number for connecting to remote computer system 116. Remote control software 120 uses communications medium 118 of computer 110 to connect to remote computer system 116 via communications path 114. Computer 110 is authenticated by remote control software 120, which is running on remote computer system 116, and a connection is established. Autodialer software 122 then performs task instructions. The tasks might involve accessing data, uploading files, downloading files, updating software, or sending a message to a user of remote computer system 116. The various software programs running on remote computer system 116, such as health monitor software program 128, self-inventory software program 130, and automatic billing user interface program 132, perform a particular task, provide information to computer 110, or retrieve information provided by computer 110.

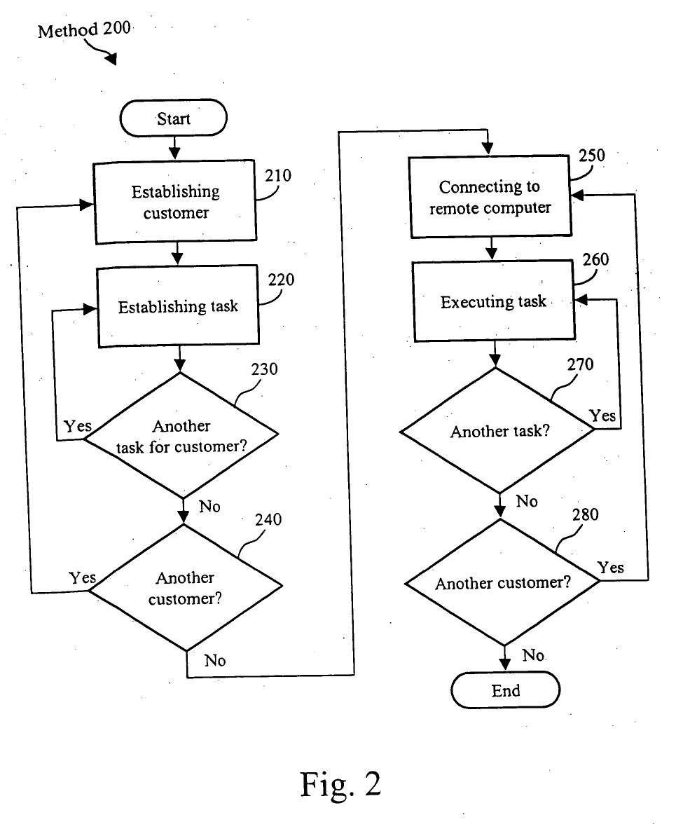

FIG. 2 illustrates a method 200 of performing a series of automated tasks across a number of remote computing systems.

At 210, a user of computer 110 reviews a list of customers contained within customer database 112 (or other conventional data storage location) comprising specific customer information and establishes that computer 110 should connect to a specific customer's remote computer system 116 to perform one or more tasks. Specific customer information can include, for example, the phone number to dial if remote computer system 116 communicates via modem, and is available in customer database 112. Using autodialer software 122, the user of computer 110 identifies the customer and uses autodialer software 122 to specify when and how computer 110 should connect to remote computer system 116.

Once a customer's remote computer system 116 is scheduled for connection, the user identifies a task to be performed during connection (220). Using autodialer software 122, the user can establish a number of different types of tasks. The type of task involves uploading a file from computer 110 to remote computer system 116, downloading a file from remote computer system 116 to computer 110, or executing a file on remote computer system 116. Specifics for the task, such as a file directory or command parameters, are specified by the user through the autodialer software 122 interface.

At 230, a decision is made whether another task needs to be scheduled for the customer's remote computer system 116. For example, an update installation file may first need to be transferred to remote computer system 116, and then executed on remote computer system 116. If the decision at 230 is ‘yes,’ the process returns to 220; if ‘no,’ the process proceeds to 240.

At 240, it is determined whether computer 110 should connect to another customer's remote computer system 116 and again perform one or more tasks. For example, a single customer may have multiple remote computer systems 116 in different locations. Therefore, it may be necessary to perform the same set of tasks for each of a customer's remote computer systems 116. If the determination at 240 ‘yes,’ the process returns to 210; if ‘no,’ the process proceeds to 250.

At 250, at the scheduled connection time, and using customer information established in step 210, autodialer software 122 initiates a new connection session by providing connection information to remote control software 120. Remote control software 120 uses communications medium 118 to connect with remote control software program 126, which is running on remote computer system 116.

At 260, the first scheduled task, as established in 220, is executed on remote computer system 116. This task may require information or processing handled by custom software applications that are running on remote computer system 116.

Whether another scheduled task needs to be executed on remote computer system 116 is determined at 270. If the determination at 270 is ‘yes,’ the process returns to 260; if ‘no,’ the process proceeds to 280.

Whether computer 110 is scheduled to connect to another customer's remote computer system 116 is determined at 280. If yes, method 200 returns to 250. If no, method 200 ends.

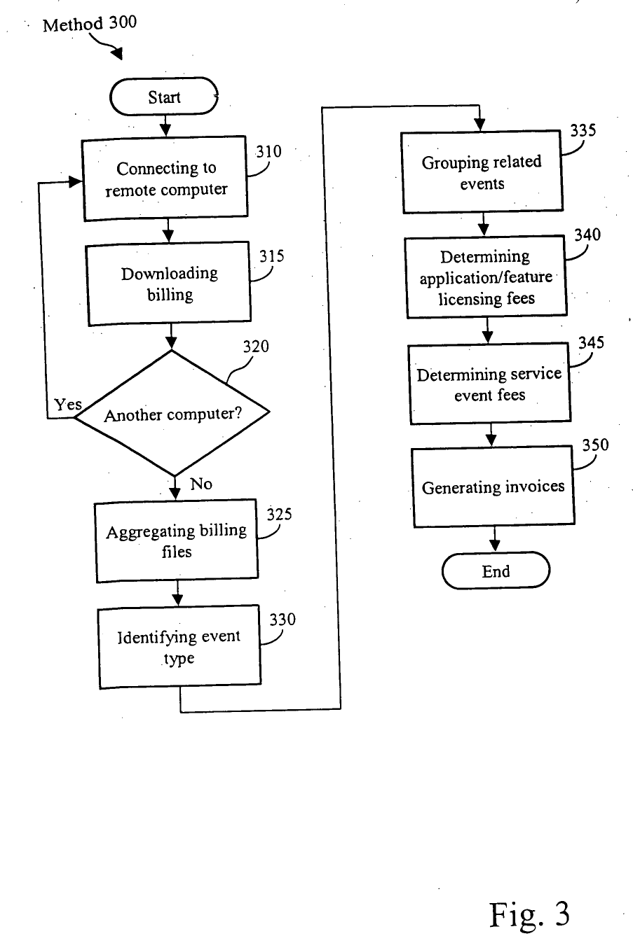

One specific task performed on remote computing systems involves downloading the billing information that is created, based on the usage of the remote computing system. FIG. 3 illustrates a method 300 of invoice generation by using downloaded billing and customer information from a number of remote computing systems.

At 310, autodialer software 122 initiates a new connection session with remote computer system 116, as described in 250.

A command is sent from computer 110 to remote computer system 116 (at 315). This may be a configuration file that is readable by automatic billing user interface program 132. Additional methods of formats for pushing the command to computer 110 can be used to realize the disclosure. Automatic billing user interface program 132 executes the command, which instructs the program to pull specific billing information from system database 134 or other conventional data storage location and send the information to computer 110 via remote control software program 126.

A determination of whether additional billing information is scheduled for download from other remote computer systems 116 is made at 320. If yes, method 300 returns to 310. If no, method 300 proceeds to 325.

When all billing information has been downloaded from one or more remote computer systems 116, billing information is effectively combined and aggregated into a single data source 325. For example, if billing information is downloaded into a series of different database or spreadsheet files, they are combined into a single file. This allows for greater flexibility during the invoicing process. In one embodiment, the user performs this process manually. In another embodiment, automated software, such as is functionally contained within autodialer software 122 or another computer program, could also be used to aggregate billing automatically.

Usage within the billing information is extracted and evaluated 330. One embodiment calculates usage based on “events,” or how many times a user performed an event on the system. Therefore, as each event is captured and stored in remote computer system 116 during usage, the type of the event is also established. However, the pricing of each event is only determined after billing is downloaded. This allows greater flexibility and accuracy in the billing process as, for example, pricing for each customer may be different or pricing may change.

Related billing events are grouped together, based on customer or other grouping criteria information (e.g., by laboratory), as captured at the time of use 335. For example, if a single customer owns multiple remote computer systems 116, each time billing information is captured in system database 134 across each remote computer system 116, the customer or other grouping criteria is also specified for each event. This allows for quick grouping of billing information, based on a specific customer, even if their billing information is collected as numerous, different billing files across numerous remote computer systems 116.

Additional billing information in the form of specific application or feature licensing fees is determined for each customer 340. A customer invoice application looks up these predetermined fees as established in customer database 112.

Additional billing information, in the form of specific service event fees, is determined for each customer 345. A customer invoice application looks up these predetermined fees as established in customer database 112.

Invoices are generated by a customer invoice application on computer 110 or other local computer system, by using aggregated billing information and other customer information, such as an address stored in customer database 112. The generated invoices are uploaded from computer 110 to the appropriate customer's remote computing system 116, by using the process as described in method 200. Method 300 ends.

The various techniques, methods, and aspects of the disclosure described herein can be implemented in part or in whole using computer-based systems and methods. Additionally, computer-based systems and methods can be used to augment or enhance the functionality described above, increase the speed at which the functions can be performed, and provide additional features and aspects as a part of, or in addition to, those of the disclosure described elsewhere in this document. Various computer-based systems, methods and implementations in accordance with the above-described technology are presented below.

A processor-based system for carrying out a method of the disclosure can include a main memory, typically random access memory (RAM), and can also include a secondary memory. The secondary memory can include, for example, a hard disk drive and/or a removable storage drive, representing a floppy disk drive, a magnetic tape drive, an optical disk drive, and the like. The removable storage drive reads from and/or writes to a removable storage medium. Removable storage medium refers to a floppy disk, magnetic tape, optical disk, and the like, which is read by, and written to by, a removable storage drive. As will be appreciated, the removable storage medium can comprise computer software and/or data.

In alternative embodiments, the secondary memory may include other similar means for allowing computer programs or other instructions to be loaded into a computer system. Such means can include, for example, a removable storage unit and an interface. Examples of such can include a program cartridge and cartridge interface (such as the found in video game devices), a movable memory chip (such as an EPROM or PROM) and associated socket, and other removable storage units and interfaces, which allow software and data to be transferred from the removable storage unit to the computer system.

The computer system can also include a communications interface. Communications interfaces allow software and data to be transferred between a computer system and external devices. Examples of communications interfaces can include a modem, a network interface (such as, for example, an Ethernet card), a communications port, a PCMCIA slot and card, and the like. Software and data transferred via a communications interface are in the form of signals, which can be electronic, electromagnetic, optical or other signals capable of being received by a communications interface. These signals are provided to communications interface via a channel capable of carrying signals and can be implemented using a wireless medium, wire or cable, fiber optics or other communications medium. Some examples of a channel can include a phone line, a cellular phone link, an RF link, a network interface, and other communications channels.

A computer program medium and computer usable medium are used to refer generally to media such as a removable storage device, a disk capable of installation in a disk drive, and signals on a channel. These computer program products are means for providing software or program instructions to a computer system.

Computer programs (sometimes referred to as computer control logic) are stored in main memory and/or secondary memory. Computer programs can also be received via a communications interface. Such computer programs, when executed, enable the computer system to perform the features of the disclosure as discussed herein. In particular, the computer programs, when executed, enable the processor to perform the features of the disclosure. Accordingly, such computer programs represent controllers of the computer system.

In an embodiment where the elements are implemented using software, the software may be stored in, or transmitted via, a computer program product and loaded into a computer system using a removable storage drive, hard drive or communications interface. The control logic (software), when executed by the processor, causes the processor to perform the functions of the disclosure as described herein.

In another embodiment, the elements are implemented primarily in hardware using, for example, hardware components such as PALs, application specific integrated circuits (ASICs) or other hardware components. Implementation of a hardware state machine so as to perform the functions described herein will be apparent to person skilled in the relevant art(s). In yet another embodiment, elements are implanted using a combination of both hardware and software.

In another embodiment, the computer-based methods can be accessed or implemented over the World Wide Web by providing access via a Web Page to the methods of the disclosure. Accordingly, the Web Page is identified by a Universal Resource Locator (URL). The URL denotes both the server machine and the particular file or page on that machine. In this embodiment, it is envisioned that a consumer or client computer system interacts with a browser to select a particular URL, which in turn causes the browser to send a request for that URL or page to the server identified in the URL. Typically the server responds to the request by retrieving the requested page and transmitting the data for that page back to the requesting client computer system (the client/server interaction is typically performed in accordance with the hypertext transport protocol (“HTTP”)). The selected page is then displayed to the user on the client's display screen. The client may then cause the server containing a computer program of the disclosure to launch an application to, for example, perform an analysis according to the disclosure.

A number of embodiments of the disclosure have been described. Nevertheless, it will be understood that various modifications may be made without departing from the spirit and scope of the disclosure. Accordingly, other embodiments are within the scope of the following claims.

1. A method comprising:
(a) identifying at least one client;
(b) connecting to a remote computer of the at least one client;
(c) obtaining billing information from the remote computer comprising at least one billing file;
(d) aggregating the billing files;
(e) identifying an event-type from the billing files;
(f) grouping related event-types;
(g) determining a billing feature related to the event-type;
(h) identifying a billing fee associated with billing feature; and
(i) generating an invoice based upon the billing fee on the remote computer.

2. The method of claim 1, wherein the at least one client comprises a plurality of clients.

3. The method of claim 2, wherein parts (b)-(i) are repeated for each of the plurality of clients.

4. A method comprising:
(a) automatically identifying at least one client from a list of clients in a database;
(b) automatically connecting to a remote computer of the at least one client; and
(c) automatically obtaining billing information from the remote computer comprising at least one billing file;
(d) automatically aggregating the billing files;
(e) automatically identifying an event-type from the billing files;
(f) automatically grouping related event-types;
(g) automatically determining a billing feature related to the event-type;
(h) automatically identifying a billing fee associated with billing feature; and
(i) automatically generating an invoice based upon the billing fee on the remote computer.

5. The method of claim 4, wherein the at least one client comprises a plurality of clients.

6. The method of claim 5, wherein parts (b)-(i) are repeated for each of the plurality of clients.

7. A computer program on a computer readable medium comprising instructions to cause a computer to carry out the methods of any one of claims 1-6.

8. A system comprising:
a local computer, the local computer comprising:
a communication component;
an autodialer component; and
a remote control component,
a client database, the customer database comprising:
customer specific information,
a remote computer, the remote computer comprising:
a communication component;
a complementary remote control component;
wherein the remote control component of the local computer comprises a computer program to cause the local computer to:
(a) identify at least one client;
(b) identify at least one task for the at least one client;
(c) connect to the remote computer of the at least one client using the communication component of the local and remote computer; and
(d) interact with the complementary remote control component to perform the at least one task on the remote computer.

9. The system of claim 8, wherein the remote computer further comprises a component selected from the group consisting of:
a health monitor component;
a self-inventory component;
an automatic billing interface component;
a system database; and
any combination thereof.

10. The system of claim 8, wherein the at least one task is a plurality of tasks.

11. The system of claim 10, further comprising repeating part (d) for each task of the plurality of tasks.

12. The system of claim 8, wherein the at least one client comprises a plurality of clients.

13. The system of claim 12, wherein parts (b)-(d) are repeated for each of the plurality of clients.

14. The system of claim 8, wherein the task comprise obtaining billing information.

15. The method of claim 14, wherein the task comprises
(i) obtaining billing information from the remote computer comprising at least one billing file;
(ii) aggregating the billing files;
(iii) identifying an event-type from the billing files;
(iv) grouping related event-types;
(v) determining a billing feature related to the event-type;
(vi) identifying a billing fee associated with billing feature; and
(vii) generating an invoice based upon the billing fee.
